(19) United States
(12) Patent Application Publication
(10) Pub. No.: US 2005/0123468 A1
(43) Pub. Date: Jun. 9, 2005

(54) Reactor for producing low surface area high/low structure carbon black and simultaneously minimizing the formation of Grit

(76) Inventors: Ghanashyam S. Mishra, Andheri (IN); Subash K. Ganguly, Patna, IN (US); Shiv S. Singh, Dist. Varanasi (IN); Pappagudi N.V. Chalam, Vadodara (IN)

Correspondence Address: Welsh & Katz, Ltd., 120 South Riverside Plaza, 22nd Floor, Chicago, IL, 60606, US

(21) Appl. No.: 10/727,429

(22) Filed: Dec. 4, 2003

(51) Int. Cl. C01D 3/00

(52) U.S. Cl. 423/449.1; 422/150

(57) ABSTRACT

The new reactor is used for the production of special grades of carbon black hitherto not designated by ASTM. The reactor is characterized by creating a vortex through separate injection inlets rather than confining walls used in the prior art to create a vortex. Carbon black produced by this reactor is characterized by high structure or low structure with low surface area. A process for the manufacture of carbon black using the new reactor is also disclosed.

### BACKGROUND OF THE INVENTION

1. Field of the Invention

This invention relates to new reactor to produce special grades of carbon black hitherto not designated by ASTM (American Society for Testing and Materials), as well as conventional carcass grade blacks. In one aspect of the new reactor, it is used to reduce the consumption of potassium used to control structure of produced carbon black.

The invention relates also to a process for producing special grades of carbon black hitherto not designated by ASTM as well as conventional carcass grade blacks with special characteristics by modifying the morphology through adjustments and control of reaction parameters e.g. vortex strength, axial velocity and skewing of the flame in the said reactor.

Carbon black produced by the new reactor and process have a high structure or low structure and characterized by low surface area and simultaneously minimizing the production of Grit.

2. Background Art

Carbon Black is a product of partially burned hydrocarbons. Carbon black is produced by partial combustion of hydrocarbons. These hydrocarbons may be in the form of liquid, gases, vapor or combination thereof. For example it may be natural gas, oils from petroleum refining plants, oils from petrochemicals pyrolisis operations, coal pyrolisis, coal tar distillation etc.

Carbon black is essentially elemental carbon in the form of extremely fine particles having an amorphous molecular structure. Within the amorphous mass is an infrastructure of microcrystalline arrays of condensed rings similar to the layered condensed ring form exhibited by graphite, which is another form of carbon. The orientation of the arrays within the amorphous mass appears to be random, consequently a large percentage of arrays have open edges of their layer planes at the surface of the particle. Associated with these open edges are large numbers of unsatisfied carbon bonds providing sites for chemical activity.

It is common in this art to refer to the smallest individually distinct unit of carbon as an aggregate and the component parts of the aggregates are called primary particles. Aggregates of carbon black are formed through the fusion of primary particles. The fusion, by which they assume a three dimensional shape of branched chains or clusters is different for different grades of carbon black and is known as structure which can be controlled in the reactors to a large extent and can be given varying degrees of clustering or aggregation. The structure of carbon black is determined by oil absorption properties as determined by ASTM D2414 and D 3493.

It is well known in the art that carbon black is produced by pyrolytical decomposition of hydrocarbon feedstock e.g. aromatic oils. The properties of carbon black can be varied in broad range depending on several parameters of the process and reactor. Some properties of carbon black are co-related so that they cannot be independently varied in a given reactor by merely changing one of the adjustable parameters. Morphology is a term used to describe the form and structure of an entity. It is applied in carbon black technology since the properties of carbon black depends, to a large extent, upon form and structure which are governed by the Aggregates Shape and Structure.

On the other hand, it is well known in the art that basic salts such as potassium is used for controlling ‘structure’ of the carbon black produced. In this conventional method, potassium ion in the form of a salt is injected into the oil or combustion stream or air. Injection of potassium reduces structure. Resultant structure is dependent on the quantity of potassium injected based on the feedstock input and is usually mentioned as a part of potassium per unit weight of the feed.

Based on the above properties and use thereof, carbon black in tire applications can be divided into two basic categories. Highly reinforcing or Hard grade commonly known as “tread blacks”. These blacks impact improved tread wear of tires as well as traction, hysteresis, and chipping resistance.

Soft grade carbon blacks are also known as “carcass blacks”. In tire applications, these carbon blacks are used in the body of tire where they impact cut growth and air retention. In tubes, it impacts tear strength, fexibilty and air retention. In Manufacture of profiles it impacts the smoothness of the surface or its defects, shrinking or swelling after extrusion which is a property required to maintain a shape or form of the extrudate.

One of the major problems in the carbon black industry is the structure of carbon black. For several applications it is always desirable to produce a carbon black with high structure, i.e. a carbon black wherein a large number of nodules are fused together to form one aggregate. Such high structure carbon black is readily processed, especially when it is employed as a filler/reinforcing agent in rubber. Not withstanding this fact carbon blacks with very low structure also play a very significant role in compounded rubber applications.

On the other hand, extraneous material such as coke (soft and hard) originated from the manufacturing process and equipment, are typically found in the so produced carbon black product. These materials are called Grit or sieve residues. These are particles retained by standard 325 mesh or 120 mesh screen when tested according to ASTM method D 1514. These particles have no importance whatsoever in reinforcement of rubber, on the contrary it can produce blemishes on the surface of extruded compounds and therefore it should be kept at absolute minimum of less than 100 ppm of mesh 325, preferably less than 10 ppm or nil in mesh 120. It has been the endeavor of the carbon black manufacturer to produce carbon black of aggregates having different structures for different applications and simultaneously minimize the formation of the said grit.

Therefore another major problem in the field of carbon black industry is to minimize the formation of Grit during the process.

Several reactors and process for the production of carbon black are well known in the art. Examples of such reactors and processes are described in several U.S. Patents, such as for example, U.S. Pat. Nos. 2,564,700; 4,094,960; 4,321,248; 4,313,921; and 6,548,036.

U.S. Pat. No.2,564,700, Krejci et al, discloses a process for the production of carbon black wherein hot combustion gases are charged to an oil furnace carbon black reactor in tangential manner to form a vortex flow of hot combustion gases within the combustion zone. Feed stock is injected axially into this vortex of hot combustion gases with axial air flow added around the feedstock injection means to be used as a cooling medium only to protect feedstock injection means from excessive heat.

U.S. Pat. No 4,094,960, John W. Vanderveen et al., discloses a reactor with a specific construction wherein the vortex is produced by a “confining walls upstream and down stream” of the combustion gases. The axial section of the reactor is essentially “Triangular” in shape. Contrary to the reactor of the present invention, no confining walls or triangular sections are used to create a vortex since vortex is created by injecting gases through separate inlets.

U.S. Pat. No. 4,321,248, Paul Cheng et al., discloses a reactor wherein the vortex formed is countered by another stream introduced in a counter movement solely for the purpose of reducing the angular movement of the primary combustion gases introduced. The ultimate objective of this arrangement appears to be only to avoid deposition of ash on the refractory. No reference was made in the said patent as to the quality of the carbon black produced by such a reactor.

U.S. Pat. No. 4,313,921, Paul Cheng et al., discloses a reactor wherein the vortex is produced by a confining wall. In another embodiment of this patent, a reactor with a “Venturi” interior and a narrower reaction chamber is also disclosed.

U.S. Pat. No. 6,548,036, lida et al, discloses a process for producing carbon blacks having lower surface area and structure wherein steam is introduced into the combustion gas stream at a certain point located a distance from the point of introduction of feedstock into the combustion gas stream. In this process it may be required to dose 100 ppm for obtaining required potassium quantity. According to the present invention, based on the choice of velocities and burner location, the quantity of potassium infused is substantially reduced as shown herein below.

### BRIEF SUMMARY OF THE INVENTION

The present invention relates to a new reactor for the production of special grades of carbon black hitherto not designated by ASTM. The reactor is characterized by creating vortex through separate injection inlets rather than confining walls. Carbon black produced by this reactor characterized by high structure or low structure with low surface area.

It is an object of the present invention to produce a carbon black with high structure or low structure with a low surface area and simultaneously minimizing the formation of the grit.

Specifically, the present invention relates to process for the production of carbon black with high and/or low structure and simultaneously minimizing the formation of Grit.

In yet another embodiment of the invention, it relates to the use of the conventional feedstock oils in the reactor and process of the invention to produce a carbon black having high structure or low structure and characterized by having low surface area with simultaneously eliminating the formation of Grit.

In yet another embodiment of the invention, it relates to new reactor which can be used to reduce the consumption of potassium used to control structure of produced carbon black.

### DISCLOSURE OF THE INVENTION

The present invention relates to reactor for the production of special grades of carbon blacks which hitherto not designated by ASTM, as well as carcass grade blacks designated by ASTM with special characteristics.

In a second embodiment of the invention, there is a process for the production of carbon black whereas method of mixing reactants (fuel & air with feedstock ) create a vortex. The process of the invention depend mainly on the control of various parameters i.e. vortex strength, axial flow, axial velocity and skewing the flame path separately in the reactor.

In one aspect of the new reactor, control of air, fuel and their ratios are carried out independently. Each of the entries has separate measuring elements for flow temperature and pressure.

In another aspect of the invention it is possible to reduce the consumption of potassium ions required to be injected by controlling the feeding and injection of feedstock, air and fuel separately.

The ratios of fuel to air are set individually for the three streams used in the new reactor. The quantities of air and fuel can be independently controlled. For example, the air rate for all three entries of the reactor can be varied in the range of 250 NM3/hr of air to about 5000 NM3/hr. Ratios of air to fuel can also be varied from 10:1 to 45:1. The rates and ratios depend on the velocity ratios required to obtain a certain property.

Feedstock used in the new reactor may be any hydrocarbon having the following characteristics:
Specific gravity of +5 to −8, preferably +4 to −6 and most preferably +3 to −6 as measured by API method.
Viscosity at 99° C. is 1 to 35, preferably 2 to 30 and most preferably 3 to 15. Units are expressed as Centi Stokes ) and are measured by ASTM test No. 445 or any international standard testing method specified for petroleum oil testing.
Asphaltenes content ranging from 2% to 10% and preferably 3% to 10% as measured by IP 143, or ASTM D 893 or ASTM D 4055 method.

In conventional reactors, contact between hydrocarbon feed and combustion gases inadequate since vortex and axial velocity can only be controlled to limited extent. The process and reactor of this invention solve this problem by establishing vortex flow in the reactor by introducing reactants through three different entries independently controlled.

One of the main objectives of the invention is to minimize the formation of certain types of extraneous matter known as Grit or sieve residues and consequently alter the morphology of the carbon black produced by this process to enable use of product of this process in many different applications e.g. tire industry, mechanical rubber goods industry, pigments, ink etc.

In the first embodiment of the invention vortex strength, axial velocity and skewing the flame are controlled and modified by injecting fuel and Air from three separate inlets to produce carbon black hitherto not designated by ASTM.

In the second embodiment, the same parameters are controlled and modified to produce conventional carcass grade blacks with special characteristics and in particular having a low surface area.

In the third embodiment of the invention, the position of the feedstock gun in relation to the centerline of the tangential entries which control the vortex strength may be varied to further control the vortex and obtain carbon black of different properties.

This and other objectives can be readily achieved by use of the new reactor and process of the invention which is designed for controlling the vortex strength, axial velocity and skew in the vortex thereby providing more thorough mixing of the reactants.

### BRIEF DESCRIPTION OF THE SVERALVIEWS OF THE DRAWINGS

The invention will be better understood in the light of the following description of specific embodiments thereof. he description shall be made with reference to the following drawings:

FIG. 1 is a schematic diagram of conventional tangentially fired tread reactor having two entries of the combustion gases.

FIG. 2 is a schematic diagram of conventional Axial tread reactor having one entry of the combustion gases.

FIG. 3 is a schematic diagram of a conventional carcass black reactor having two tangential entries and feedstock injector axially.

FIG. 4 is a schematic diagram of a reactor according to the present invention whereas three ports are provided for introducing combustion gases.

FIG. 5 is an enlarged schematic diagram of the preferred embodiment of the invention showing the internal arrangement.

FIG. 6 is a cross sectional view taken along the line A-A in FIG. 5.

FIG. 7 is a schematic diagram shows the vortices formed by two tangential entries, the resultant induced velocity and the inner boundary created by the axial input.

FIG. 8 is an end view of the expected skewing of flame resulting from pattern shown in FIG. 7.

FIG. 9 is a schematic diagram that shows a visualised representation of the expected skewing of flame as a result of rotation of vortices.

FIG. 10 is an end view of the expected skewing of flame resulting from pattern shown in FIG. 9.

FIG. 11 is a schematic diagram shows controls used with the new reactor to control each inlet separately for achieving the objectives of the present invention.

### DETAILED DESCRIPTION OF THE INVENTION

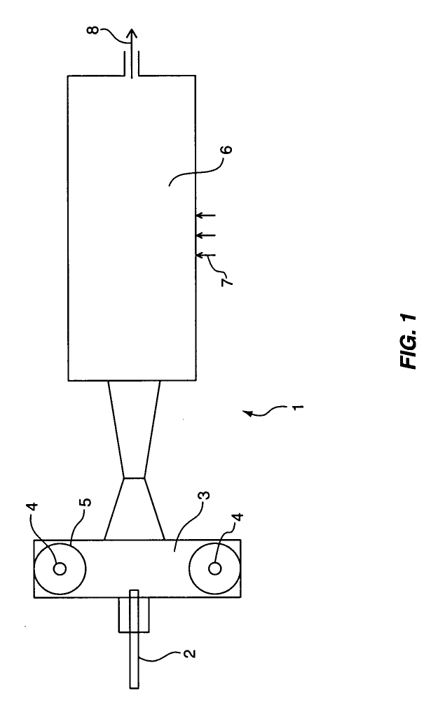

With reference to the accompanying drawing, FIG. 1 is a schematic diagram of a typical conventional tangentially fired tread reactor (1). Feedstock is injected through inlet (2) to tangential chamber (3) wherein a tangential fuel (4) is injected through tangential port (5). The resulting product is discharged to quench chamber (6) to quench ports (7) and product is collected and converted to conventional pelletizing system through (8) to obtain pellets which are dried and packed.

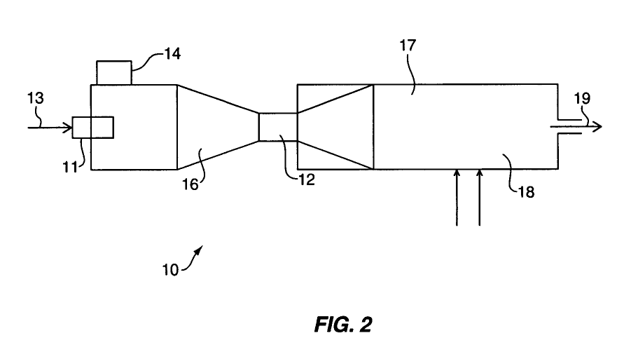

FIG. 2 is schematic diagram of another conventional Axial tread reactor (10) having one entry of the combustion gases (14). Fuel is injected through fuel inlet at one end (11). A stream of air in injected through an inlet (13) and the feedstock is injected into chamber (16) through ports (15).

Reaction products are processed through a reaction chamber (17) and to a quench chamber (18) and quenched with water. End product is collected through ports (19) and converted to conventional pelletizing system to obtain pellets, which are dried and packed.

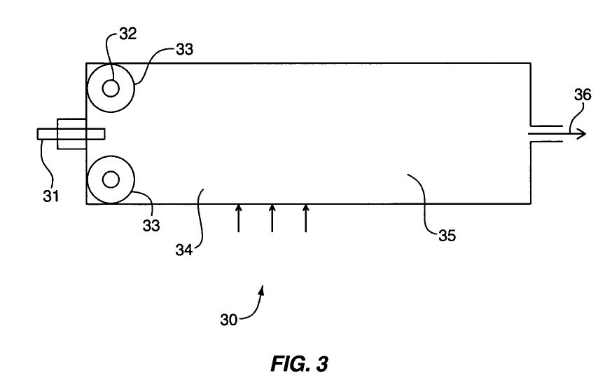

FIG. 3 is schematic diagram of a conventional carcass black Reactor (30). Feedstock is charged through the feedstock gun (31). Air alone or fuel and air are injected tangentially through inlets (32) and (33) respectively. Reactions proceed in the reaction zone (34) and resulting smoke stream pass to a quench chamber (35) wherein it is quenched. End product is collected through ports (36) and converted to conventional pelletizing system to obtain pellets which are dried and packed.

Although these conventional reactors are effectively used in the industry, however, when using these reactors in the production of carbon black, the resulting carbon black shall not have the specific characteristic mentioned herein above and in particular the low surface area for a given structure, however, it shall also contain some Grit. This is mainly due to the fact that contact between feedstock, fuel and/or air inadequate and different parameters of the process cannot be controlled to control characteristics of the so produced carbon black.

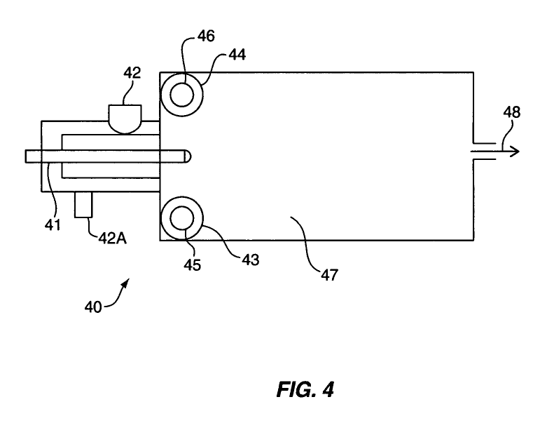

Essential parameters of the process can effectively be controlled using the new reactor of the invention shown in FIG. 4.

Reactor of the invention (40) having main feedstock port (41) to charge the feedstock. Air is injected axially through inlet (42) and injected tangentially through inlet (43, 44),and fuel is injected axially through inlet (42A). Fuel is also injected tangentially through inlets (45, 46).

Accordingly, fuel is injected axially and tangentially through separate injection ports (42A, 45 & 46 respectively) allowing separate control of each injection inlet in respect of velocity and volume of fuel injected.

Likewise, air is introduced axially and tangentially through ports (42, 43, 44 respectively) allowing separate control of each injection inlet in respect of velocity and volume of air injected.

In the new process of the invention feedstock is charged to reactor chamber wherein air is introduced axially and tangentially through ports (42, 43, 44) respectively and fuel is introduced axially and tangentially through three ports (42A, 45, 46). Vortex is controlled by controlling the quantity of air and fuel gases injected to reaction chamber (47) through different injection inlets. End product is collected through ports (48) and converted to custom pelletizing system to obtain pellets which are dried and packed.

The new process of the invention is based on 3 principles to control different parameter of the process, those are:
1—Helmholtz Vortex theorems
2—Formation of the vortex filaments in a vortex.
3—Principles of three dimensional flows.

In 1858, Holmholtz summarized some properties of vortex theorems which control the behavior of in viscid three-dimensional vortices:
A—Vortex strength is constant.
B—Vortices are infinitude (end on boundaries or form a closed path).
C—Vortices move with the flow.

In the process of the invention carried out in the new reactor, two main parameters have been considered and controlled. The vortex strength which can be controlled by tangential flow through inlets (43, 44, 45, 46). The vortex will be axisymmetric provided so that the flame is not intentionally skewed. Since air and fuel are continuously admitted into reactor chamber this result in keeping the vortex moving and axial velocity is induced. The said induced axial velocity, which would be dependent on the vortex created, is enhanced by introduction of air, fuel and feedstock axially. A radial velocity, depending on the vortex strength is also created by the vortex.

The process of the invention depend mainly on introducing three flows of the three reactants in certain balance to achieve the ideal velocity required for specific grade of carbon black.

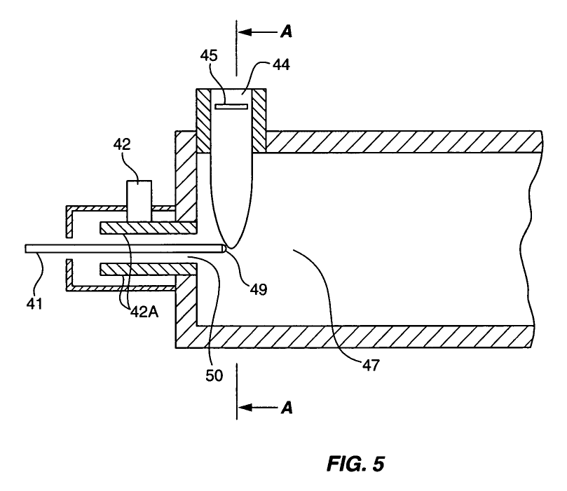

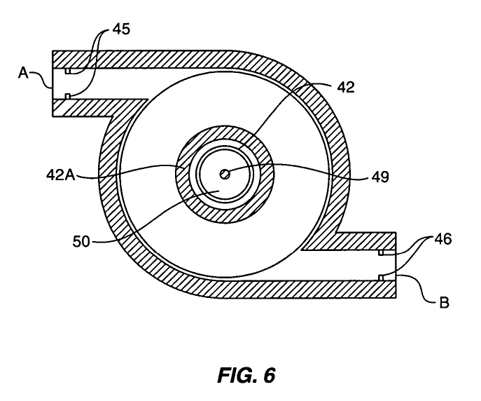

FIG. 5 is a schematic diagram of the preferred embodiment of the invention showing in detail the internal arrangement of the reactor (40). Feedstock is charged through a feedstock gun (41). The outlet of the feedstock gun is located under the path of the flame emanating from the flame coming from the tangential fuel port (44) or in the flame path coming through the axial entry through the inlet (50). Axial air is injected through the inlet (42) and fuel is also injected axially through port (42A). In order to explain the arrangement of feeding fuel & Air axially and tangetially a cross section has been taken along the line A-A shown in FIG. 6.

FIG. 6 shows in details the tangential fuel entries (A) and (B) wherein fuel is injected tangentially through inlets (45) and (46). The outlet of the feedstock gun (49) is centered wherein axial fuel burner (42A) and Axial air entry port (42) are surrounding the outlet of the feedstock gun.

In the main aspect of the invention all three quantities can be independently varied and controlled. By controlling the quantity injected through each inlet, it is possible to control the quality of the carbon black to meet special requirements.

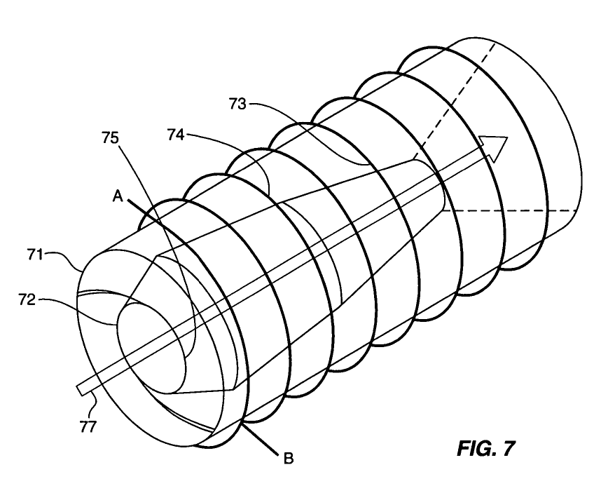

The arrangement of the different axial and tangential air and fuel creates a vortex. FIGS. 7, 8, 9 and 10 show the vortices formed by the two tangential entries, the resultant induced velocity and the inner boundary created by the axial input.

In FIG. 7, the tangentially entering combustion gases are the vortex sources. In this figure the combination of the Axial velocity 73, Tangential velocity 74, and radial velocity 75 lead to final axial velocity 77. They will form a “Double Helix” 71 and 72 by the inner diameter of the reactor. Strength will depend on the quantity and velocity at the tangential inlets. The letter A show the velocity at the upper tangential entry and the letter B shows the velocity at the lower tangential entry.

When A equals B the helices formed by two different entries are in harmony and given rise to certain products for a given axial velocity.

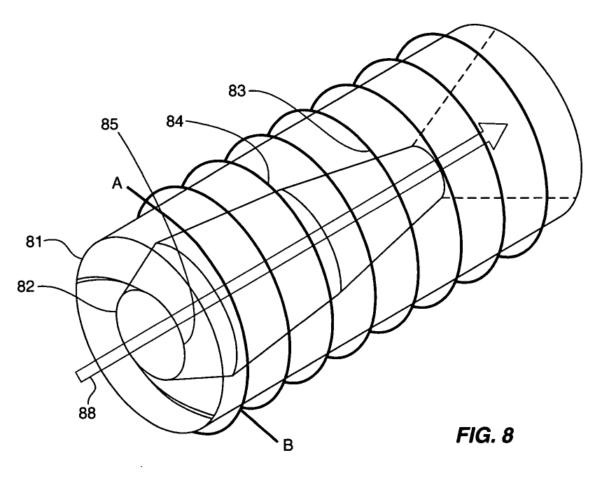

FIG. 8 is end view of the skewed flame produced by the arrangement shown in FIG. 7 wherein flame is expected to skew because vortices will rotate at different phase angles.

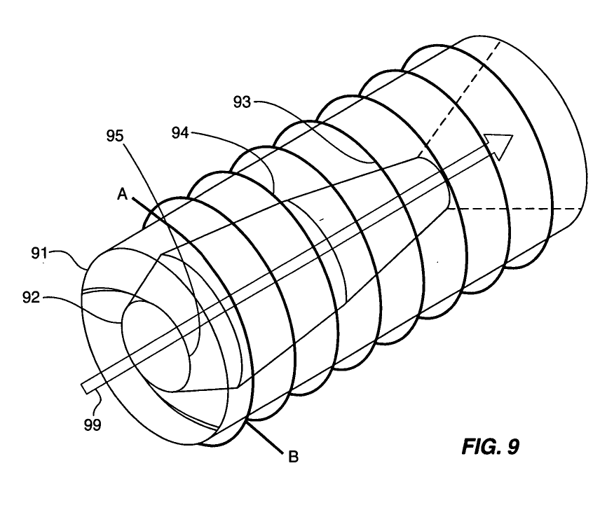

For a given Axial velocity when the two inlet velocities forming the helices (A & B) are not equal an entirely different results will be produced. FIG. 9 show visualized representation of this arrangement. The tangentially entering combustion gases are the vortex sources. In this figure the combination of the Axial velocity 93, Tangential velocity 94, and radial velocity 95 lead to final axial velocity 99. They will form a “Double Helix” 91 and 92 by the inner diameter of the reactor. In this case helices caused by inlets A & B are not equal.

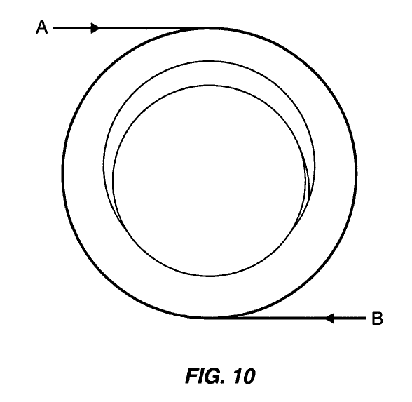

FIG. 10 is end view of the skewed flame produced by the arrangement shown in FIG. 9 wherein flame is expected to skew because vortices will rotate at different phase angles.

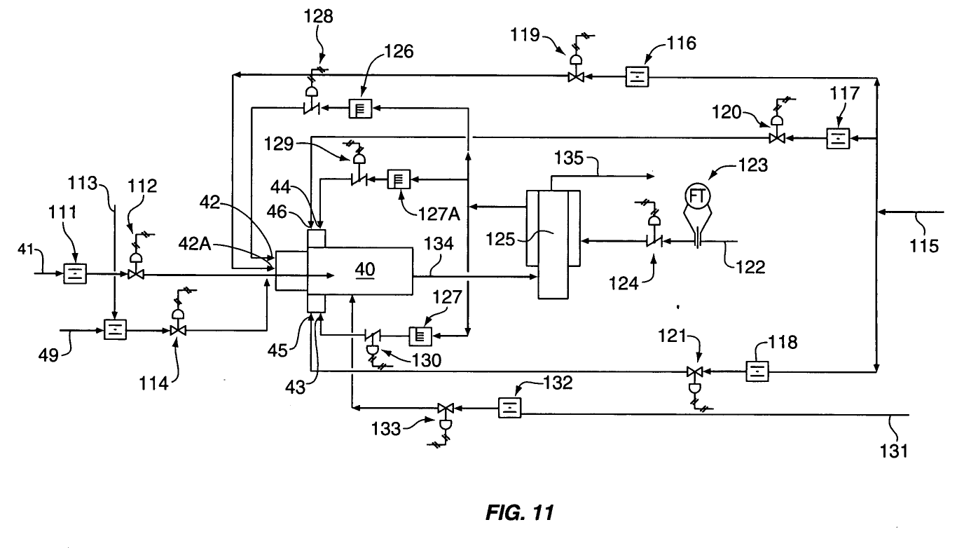

FIG. 11 schematic diagram shows controls used with the new reactor to control each inlet separately. Reactor 40 is receiving feedstock, fuel and air through seven separate entries. Feedstock is injected from the main line (41) into mass flow meter (111) to plug type control valve (112) Potassium is added to feedstock from the main line (49) through mass flow meter (113) to plug type control valve (114).

Fuel, Natural gas, is injected from the main line (115) to mass flow meters (116, 117 and 118). For injecting fuel axially, fuel from mass flow meter (116) is directed to plug type control valve (119) to axial injection inlet (42A). For injection of fuel tangentially from mass flow meter (117) is directed to plug type control valve (120) to tangential inlet (46)and fuel from mass flow meter (118) is directed to plug type control valve (121)to tangential inlet (45).

Air in injected from the main line (122) to orifice flow meter (123) to plug type control valve (124) to air pre-heater (124). Hot air is then directed to three Annubar (averaging pilot tube) (126, 127 and 127A). For injecting air axially, hot air from Annubar (125) is directed to butterfly control valve (128) to axial injection inlet (42). For injection of air tangentially, hot air from Annubars (126, 127A) is directed to butterfly control valves (129, 130) to tangential inlets (44, 43) respectively.

Water is used to quench reaction from main source (131) whereas it is directed to mass flow meter (132) to plug type control valve (133) to quenching chamber. Smoke (134) coming out of reactor (40) is directed to pre heater unit (125) for recovering heat and pre-heat air to feed to reactor to CB for collection (135).

In another aspect of the invention, it relates to new process for the production of carbon black by pyrolytical decomposition of hydrocarbon comprising the following steps:
A—Introducing the hydrocarbon feedstock along the center of the reactor.
B—Introducing combustion gases axially and tangentially through separate inlets.
C—Introducing air axially and tangentially through separate inlets.
D—By separate control of quantities and velocity of combustion gases and air introduced through each inlet, it is possible to change the quality of the produced carbon black.

In this process Axial velocity of injecting fuel or, air ranging from 30 met/sec to 200 met/sec and preferably from 50 to 180 met/sec most preferably between 60 to 160 met/sec, whereas tangential velocity ranging from 30 to 350 met/sec preferably between 50 to 300 met/sec and most preferably between 60 to 270 met/sec.

The following examples illustrate the effectiveness and advantages of the present invention, but do not in any way limit the scope of the present invention. It should be noted that the reactor used in the following examples is identical with this shown in FIG. 4.

In the following examples, the following abbreviations have been used.
Vₓ=Axial velocity.
Vₜₐ=tangential velocity of tangential Inlet A.
V_{tb}=tangential velocity of tangential Inlet B.

### EXAMPLE 1

The process of the present invention was utilized to produce carbon black in seven exemplary reactor runs.

The reactor utilized in each example run was similar to the reactor of the invention as generally described herein, and as depicted in FIG. 4, utilizing the reactor conditions and geometry set forth in Table 2. The fuel utilized in the combustion reaction in each of the examples was natural gas The feedstock utilized in each of the Example Runs was hydrocarbon oil black.

Using reactor of the invention, several runs were made to explain the effect of controlling varies inlets velocities and quantities on the properties of the final carbon black produced.

Parameters used in this example as follows:
Vₜₐ=V_{tb}
Vₓ/(Vₜₐ or V_{tb})=0.18
Feedstock gun position 0.0
Carbon black of the following characteristic was obtained.
Iodine number gm/Kg Carbon (ASTM D1510)=20.00
DBP Number 10⁻⁵ m³/Kg (ASTM D 2414)=60.00
DBP Number of compressed Sample 10⁻⁵ m³/Kg (ASTM D 3493)=58.00
Sieve residue in 325 mesh (Standard Mesh) ppm=10.00
Sieve residue in 120 mesh (Standard Mesh) ppm=Nil

The following table (I) summaries axial velocities and tangential velocities used in several runs. Table (II) summaries the characteristics of the resulting carbon black. Table (III) shows a comparison of the consumption of potassium as ppm of the feed for a conventional reactor as shown in the figure and the invented reactor. Table (IV) Chart/graph shows the DBP values as a function of the velocity ratios and as a function of the radial velocity created by the vortex.

TABLE (I)

| | Momentum | | | | | | Burner | | |
|---|---|---|---|---|---|---|---|---|---|
| | KgM²/sec | | KgM²/sec | | | | Posn | | |
| Example | Ma | Vta | Mb | Vx/Vta | Vx/Vtb | rad vel | mm | Iodine. No | DBP |
| 1 | 0.730 | 271 | 0.730 | 0.18 | 0.18 | 7.30 | 50 | 18.5-20.4 | 58.5-59.7 |
| 2 | 0.642 | 239 | 0.642 | 0.28 | 0.28 | 6.42 | 0 | 23.8-25.7 | 66.5-68.1 |
| 3 | 0.481 | 179 | 0.481 | 0.56 | 0.56 | 4.81 | −50 | 30.1-32.5 | 118-120.3 |
| 4* | 0.562 | 209 | 0.401 | 0.48 | 0.67 | 5.62 | −50 | 30.1-32.8 | 124.2-127.0 |
| 5 | 0.321 | 119 | 0.321 | 1.12 | 1.12 | 3.21 | −100 | 35.4-36.6 | 90.5-92.3 |
| 6 | 0.241 | 89 | 0.241 | 1.68 | 1.68 | 2.41 | −150 | 41.8-43.2 | 122.0-124.2 |
| 7 | 0.160 | 60 | 0.160 | 2.80 | 2.80 | 1.60 | −200 | 53.8-55.7 | 131.8-134.2 |

*Skewed flame

TABLE (II)

| | | | | Grit #325 | |
|---|---|---|---|---|---|
| | I₂ No. | DBP | CDBP | ASTM D | Grit #120 |
| | ASTM D 1510 | ASTM D2414 | ASTM D3493 | 1514 | ASTM D 1514 |
| Example | g/kg | 10\hat{ }−5 m3/kg | 10\hat{ }−5 m3/kg | ppm | ppm |
| 1 | 18.5-20.4 | 58.5-59.7 | 57.2-58.0 | <10 | Nil |
| 2 | 23.8-25.7 | 66.5-68.1 | 67.25-68.2 | <8 | Nil |
| 3 | 30.1-32.5 | 118-120.3 | 81.5-82.3 | <9 | Nil |
| 4 | 30.1-32.8 | 124.2-127.0 | 84.1-86.3 | <6 | Nil |
| 5 | 35.4-36.6 | 90.5-92.3 | 75.3-76.8 | <7 | Nil |
| 6 | 41.8-43.2 | 122.0-124.2 | 83.1-84.7 | <6 | Nil |
| 7 | 53.8-55.7 | 131.8-134.2 | 95.4-97.2 | <5 | Nil |

TABLE (III)

| | DBP | Pot Reqd. | |
|---|---|---|---|
| | ASTM D2414 | reactor FIG. 3 | Pot Reqd. Inv. reactor |
| Example | 10\hat{ }−5 m3/kg | Ppm of oil feed | ppm of oil feed |
| 1 | 58.5-59.7 | 180.0 | 14 |
| 2 | 66.5-68.1 | 40.0 | 5 |
| 3 | 118-120.3 | 70.0 | 5 |
| 3 | 124.2-127.0 | 28.0 | 5 |
| 4 | 90.5-92.3 | 18.0 | 3 |
| 5 | 122.0-124.2 | 320.0 | 14 |
| 6 | 131.8-134.2 | 40.0 | 4 |
| 7 | 58.5-59.7 | 22.0 | 2 |

It is to be understood that the subject invention is not to be limited by the exact description set forth herein. These have been provided merely to demonstrate operability, selection of various parameter can be determined from the total specification disclosure provided, without departing from the spirit of the invention disclosed and described, the scope of the invention including modifications and variations that fall within the scope of the attached claims.

1- Reactor for the production of carbon black characterized in that said reactor comprises:
a feeding gun for feeding hydrocarbon feedstock;
said reactor having three inlets for combustion gases and,
three inlets for air.

2- Reactor according to claim 1 characterized in that the position of the feedstock gun in relation to a centerline of tangential entries which controls a vortex strength is varied to control the vortex and to obtain carbon black of different properties.

3- Reactor according to claim 1 characterized in that injection of combustion gases and air axially and tangentially is made separately.

4- Reactor according to claim 3 characterized in that combustion gases are injected axially and tangentially through three separate inlets.

5- Reactor according to claim 4 characterized in that combustion gases are injected axially through one inlet and tangentially through two inlets.

6- Reactor according to claim 3 characterized in that air is injected axially and tangentially through three separate inlets.

7- Reactor according to claim 6 characterized in that air is injected axially through one inlet and tangentially through two inlets.

8- Reactor according to claim 3 wherein a vortex strength is controlled through controlling tangential flow of each separate inlet.

9- Reactor for the production of carbon black according to claim 1 wherein a vortex is controlled by controlling velocities and quantities of injected combustion gases and air at each inlet separately.

10- Reactor for the production of carbon black according to claim 1 wherein potassium required to control structure is substantially reduced due to the separate control of injected reactants.

11- Process for the production of carbon black by pyrolytical decomposition of hydrocarbon comprising the following steps:
introducing the hydrocarbon feedstock along the center of the reactor;
introducing combustion gases axially and tangentially through separate inlets;
introducing air axially and tangentially through separate inlets; and,
by separate control of quantities and velocity of combustion gases and air introduced through each inlet, changing the quality of the produced carbon black.

12- Process according to claim 11 wherein combustion gases are injected axially through one inlet and tangentially through two inlets.

13- Process according to claim 11 wherein air is injected axially through one inlet and tangentially through two inlets.

14- Process according to claim 11 characterized in that the Axial velocity of injecting fuel or, air ranging from 30 met/sec to 200 met/sec and preferably from 50 to 180 met/sec most preferably between 60 to 160 met/sec.

15- Process according to claim 11 characterized in that tangential velocity ranging from 30 to 350 met/sec preferably between 50 to 300 met/sec and most preferably between 60 to 270 met/sec.

16- The process according to claim 11 characterized in that ratio of axial velocity to tangential velocity fall within the range of 0.1 to 5.3 preferably between 0.5 to 2.5.

17- Process according to claim 11 characterized in that quantity of potassium required to control structure is substantially reduced.

18- Carbon black produced in accordance with the process of claim 11 characterized in that it has a low surface area with minimum content of grit.

19- Carbon black produced in accordance with the reactor of claim 1 characterized in that it has a low surface area with minimum content of grit.
